(19) United States
(12) Patent Application Publication
(10) Pub. No.: US 2018/0211268 A1
(43) Pub. Date: Jul. 26, 2018

(54) MODEL-BASED SEGMENTATION OF CUSTOMERS BY LIFETIME VALUES

(71) Applicant: LinkedIn Corporation, Sunnyvale, CA (US)

(72) Inventors: Xing Zhou, Mountain View, CA (US); Wenrong Zeng, Sunnyvale, CA (US); Juan Wang, Los Altos, CA (US)

(73) Assignee: LinkedIn Corporation, Sunnyvale, CA (US)

(21) Appl. No.: 15/411,553

(22) Filed: Jan. 20, 2017

(51) Int. Cl. G06Q 30/02; G06F 17/18

(52) U.S. Cl. CPC G06Q 30/0204; G06Q 30/0201; G06F 17/18

(57) ABSTRACT

The disclosed embodiments provide a system for processing data. During operation, the system obtains a set of predicted growth rates for a first set of customers of a product. Next, the system uses a set of features comprising the predicted growth rates to generate a set of customer segments for the product, wherein each customer segment in the set of customer segments includes a similar growth rate and a similar potential spending. For each customer segment in the set of customer segments, the system uses the similar growth rate and the similar potential spending to calculate a customer lifetime value (CLV) for the customer segment. Finally, the system outputs the CLV with a second set of customers assigned to the customer segment for use in managing sales activity with the second set of customers.

### BACKGROUND

### Field

The disclosed embodiments relate to techniques for managing sales activities. More specifically, the disclosed embodiments relate to techniques for performing model-based segmentation of customers by lifetime values.

### Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating a process of obtaining a predicted growth rate for a customer of a product in accordance with the disclosed embodiments.

FIG. 5 shows a flowchart illustrating a process of calculating a customer lifetime value (CLV) for a customer segment in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

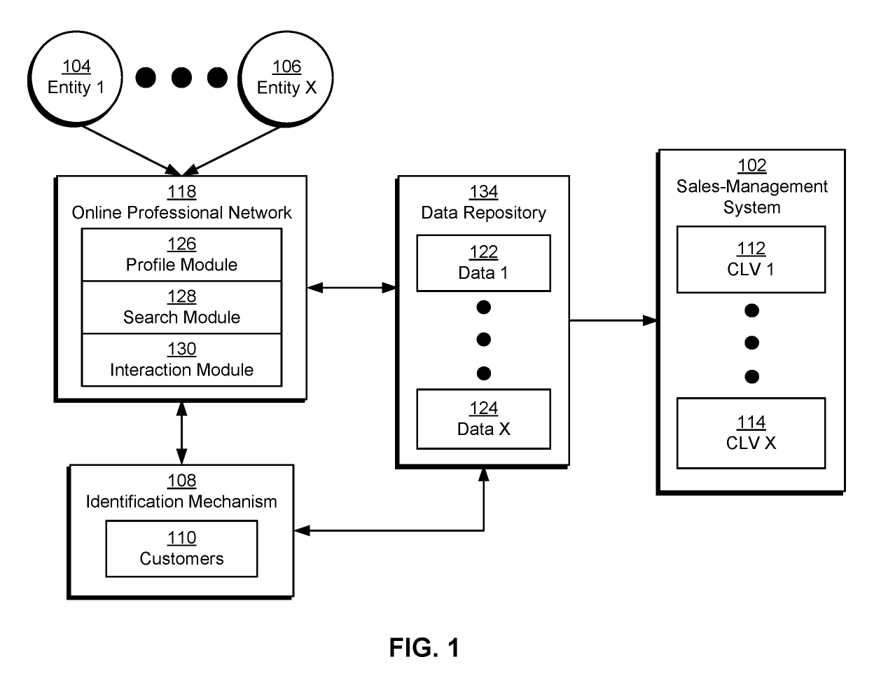

The disclosed embodiments provide a method, apparatus, and system for processing data. More specifically, the disclosed embodiments provide a method, apparatus, and system for performing model-based segmentation of customers in a social network by lifetime values. As shown in FIG. 1, the social network may be an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use online professional network 118 to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills. The profile module may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on the online professional network to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, the online professional network may include a homepage, landing page, and/or newsfeed that provides the latest postings, articles, and/or updates from the entities' connections and/or groups to the entities. Similarly, the online professional network may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing data repository 134.

The entities may also include a set of customers 110 that purchase products through online professional network 118. For example, the customers may include individuals and/or organizations with profiles on the online professional network and/or sales accounts with sales professionals that operate through the online professional network. As a result, the customers may use the online professional network to interact with professional connections, list and apply for jobs, establish professional brands, purchase or use products offered through the online professional network, and/or conduct other activities in a professional and/or business context.

Customers 110 may also be targeted for marketing or sales activities by other entities in online professional network 118. For example, the customers may be companies that purchase business products and/or solutions that are offered by the online professional network to achieve goals related to hiring, marketing, advertising, and/or selling. In another example, the customers may be individuals and/or companies that are targeted by marketing and/or sales professionals through the online professional network.

As shown in FIG. 1, customers 110 may be identified by an identification mechanism 108 using data from data repository 134 and/or online professional network 118. For example, identification mechanism 108 may identify the customers by matching profile data, group memberships, industries, skills, customer relationship data, and/or other data for the customers to keywords related to products that may be of interest to the customers. Identification mechanism 108 may also identify the customers as individuals and/or companies that have sales accounts with the online professional network and/or products offered by or through the online professional network. As a result, the customers may include entities that have purchased products through and/or within the online professional network, as well as entities that have not yet purchased but may be interested in products offered through and/or within the online professional network.

Identification mechanism 108 may also match customers 110 to products using different sets of criteria. For example, the identification mechanism may match customers in recruiting roles to recruiting solutions, customers in sales roles to sales solutions, customers in marketing roles to marketing solutions, and customers in advertising roles to advertising solutions. If different variations of a solution are available, the identification mechanism may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, the customers may include all entities in the online professional network, which may be targeted with products such as “premium” subscriptions or memberships with the online professional network.

After customers 110 are identified, they may be targeted by one or more sales professionals with relevant products. For example, the sales professionals may engage the customers with recruiting, marketing, sales, and/or advertising solutions that may be of interest to the customers. After a sales deal is closed with a given customer, a sales professional may follow up with the customer to improve the customer lifetime value (CLV) (e.g., CLV 1 112, CLV x 114) and retention of the customer.

To facilitate prioritization of sales activities with the customers, a sales-management system 102 may perform segmentation of the customers by CLV and/or other attributes. As described in further detail below, the sales-management system may predict a set of growth rates for the customers and use the growth rates and/or other attributes of the customers to generate a set of customer segments for a product, such as a product offered by or through online professional network 118. The sales-management system may then use historic data associated with customers in a given customer segment to calculate a CLV for the customer segment. In turn, the calculated CLV may be outputted with customers assigned to the customer segment to facilitate sales and/or business operations such as territory planning, acquisition channel selection, marketing, and/or total addressable market (TAM) analysis.

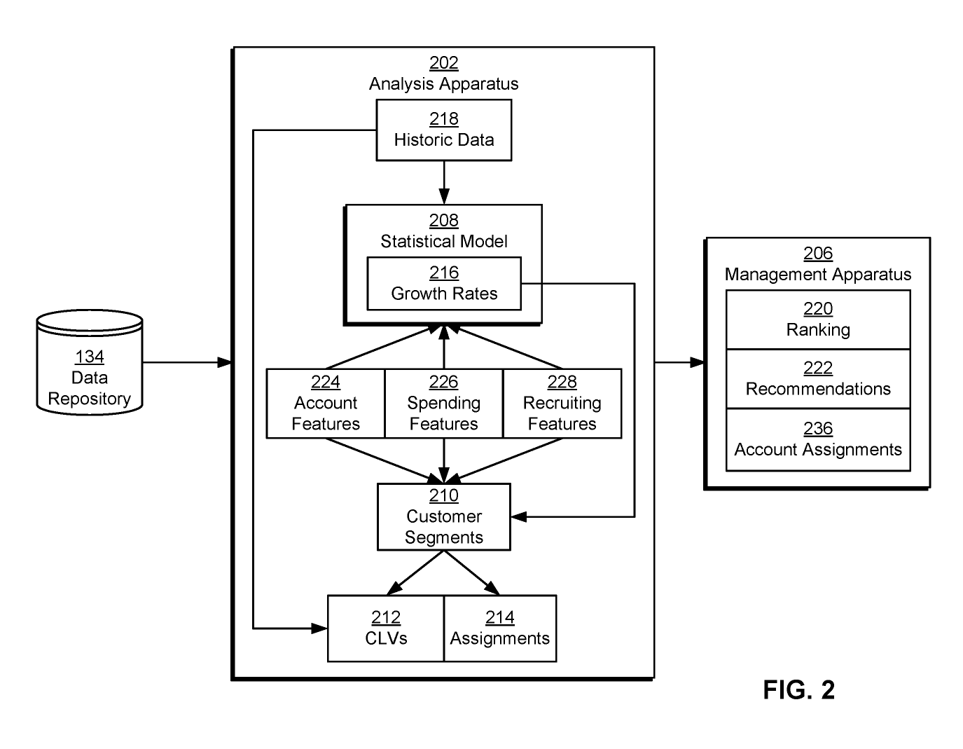

FIG. 2 shows a system for processing data in accordance with the disclosed embodiments. More specifically, FIG. 2 shows a sales-management system, such as sales-management system 102 of FIG. 1, that uses CLVs 212 and customer segments 210 associated with a product to manage sales activity for the product. As shown in FIG. 2, the system includes an analysis apparatus 202 and a management apparatus 206. Each of these components is described in further detail below.

Analysis apparatus 202 may use a statistical model 208 to predict a set of growth rates 216 for customers of a product. Each customer may be a current or prospective customer that is identified using data from data repository 134. Analysis apparatus 202 may also use data from data repository 134 to generate a set of features for the customer, including one or more account features 224, one or more spending features 226, and one or more recruiting features 228. For example, analysis apparatus 202 may use one or more queries or operations to obtain the features directly from data repository 134, extract one or more features from the queried data, apply transformations to the features, and/or aggregate the queried data into one or more features.

Account features 224 may include attributes and/or metrics associated with a customer and/or the customer's sales account. Account features for a customer that is a company may include demographic attributes such as a location, an industry, a company type (e.g., corporate, staffing, etc.), an account type (e.g., sales account, account with an online professional network, etc.), and/or account tier (e.g., small business, medium/enterprise, global/large, etc.) of the company. The demographic attributes may also include a geographic tier representing the maturity of the market for the product in the company's location (e.g., country, region, etc.).

Account features 224 may also include metrics associated with membership of the company's employees with an online professional network (e.g., online professional network 118 of FIG. 1). For example, company features 224 may include a number of employees who are members of the online professional network, a number of employees at a certain level of seniority (e.g., entry level, mid-level, manager level, senior level, etc.) who are members of the online professional network, and/or a number of employees with certain roles (e.g., engineer, manager, sales, marketing, executive, etc.) who are members of the online professional network. In turn, the metrics may be used to estimate the size of the company and/or the distribution of roles in the company.

Spending features 226 may be related to the spending behavior of the customer. For example, the spending features may include metrics related to the customer's historic and/or projected spending on one or more products (e.g., marketing solutions, sales solutions, talent solutions, etc.) offered through the online professional network. In turn, the spending features may be used to calculate a spending growth rate as the year-over-year difference (e.g., an amount of increase or decrease) in the customer's spending for a previous pre-specified number of years. The spending features may also include the customer's spending amounts over the same number of years and/or an average spending amount for the customer. Finally, the spending features may include a potential spending that represents the maximum future spending of the customer with the product, independent of the customer's likelihood of purchasing the product.

Recruiting features 228 may identify recruiting activity of the customer. For example, recruiting features 230 may include the number of recruiters, talent professionals (e.g., human resources staff), hiring months, and/or hires for the customer's company.

Account features 224, spending features 226, and/or recruiting features 228 may also track changes to the metrics over time. As mentioned above, a growth rate in the spending features may track year-over-year changes in the customer's spending. Similarly, the account and recruiting features may include year-over-year changes to the company's size, membership numbers in the online professional network, number of recruiters, and/or number of hires.

After account features 224, spending features 226, and recruiting features 228 are obtained from data repository 134, analysis apparatus 202 may modify some or all of the features. First, the analysis apparatus may apply imputations that add default values, such as zero numeric values or median values, to features with missing values. Second, the analysis apparatus may “bucketize” numeric values for some features (e.g., number of employees, growth rate, etc.) into ranges of values and/or a smaller set of possible values. Third, the analysis apparatus may apply, to one or more subsets of features, a log transformation that reduces skew in numeric values and/or a binary transformation that converts zero and positive numeric values to respective Boolean values of zero and one. Fourth, the analysis apparatus may normalize scores to be within a range (e.g., between 0 and 10), verify that feature ratios are within the range of 0 and 1, and perform other transformations of the features. In general, such preprocessing and/or modification of features by the analysis apparatus may be performed and/or adapted based on configuration files and/or a central feature list.

Next, analysis apparatus 202 may predict growth rates 216 of the customers by inputting the features into a statistical model 208. For example, statistical model 208 may be a random forest and/or other predictive model that generates a sequence of spending values for a customer over time based on the customer's features. In turn, the analysis apparatus may use the sequence of spending values to calculate a predicted growth rate for the customer.

Continuing with the previous example, the output of statistical model 208 may include the following values:

y₀: spending at onboarding

y₁: spending within the first year after onboarding

y₂: spending within the second year after onboarding

y₃: spending within the third year after onboarding

The values may then be combined into a predicted growth rate g using the following formula:

g=(y₀+y₁+y₂+y₃)/(3*y₀)−1

In other words, the growth rate may be calculated as the percentage change in spending over the three years following the customer's onboarding with the product.

Analysis apparatus 202 and/or another component of the system may use historic data 218 from data repository 134 to train and/or validate statistical model 208. For example, the component may use a set of features and historic values of onboarding, first-year, second-year, and third-year spending from existing customers of the product to train the statistical model. The component may then use a different set of features and historic values of spending from other existing customers to verify that the output of the statistical model matches the historic values within a certain threshold of accuracy.

Analysis apparatus 202 may then use the outputted growth rates 216 from statistical model 208 and/or some or all account features 224, spending features 226, and/or recruiting features 228 to generate a set of customer segments 210 for the product. For example, the analysis apparatus may use a k-means clustering technique to generate the customer segments as clusters of customers with similar or identical growth rates, potential spending, industry, region, account tier, geographic tier, and/or other features. After the customer segments are produced, the analysis apparatus and/or another component may verify the similarity of growth rates, potential spending, historic spending, and/or other spending-related attributes over the first three years after onboarding for existing customers in each customer segment.

Analysis apparatus 202 may also generate a set of classification rules for assigning customers to customer segments 210 based on features that are common to each customer segment. In turn, the analysis apparatus may use the classification rules to generate assignments 214 of additional customers to the customer segments. For example, the analysis apparatus may train a decision tree to output, for a prospective customer of the product, an identifier for a customer segment based on the customer's predicted growth trend from statistical model 208, potential spending, industry, location, and/or other features.

Finally, analysis apparatus 202 may use historic data 218 associated with existing customers of the product to calculate a set of CLVs 212 for customer segments 210. For example, the analysis apparatus may obtain, from assignments 212 and/or the clusters used to generate the customer segments, a set of existing customers in each customer segment. The analysis apparatus may then calculate an average growth rate and an average spending for the set of existing customers and combine the average growth rate and average spending to obtain a CLV for the customer segment.

Continuing with the previous example, the analysis apparatus may use historic data 218 for existing customers in a customer segment to calculate the following values:

Y₁: average spending within the first year after onboarding

Y₂: average spending within the second year after onboarding

Y₃: average spending within the third year after onboarding

Y₁ may be calculated using values of first-year spending from existing customers in the customer segment that are at least a year old. Y₂ may be calculated using values of second-year spending from existing customers in the customer segment that are at least two years old. Alternatively, Y₂ may be calculated by multiplying Y₁ by the average growth rate from the first to second year after onboarding for existing customers that are at least two years old. Y₃ may be calculated using values of third-year spending from existing customers in the customer segment that are at least three years old. Alternatively, Y₃ may be calculated by multiplying Y₂ by the average growth rate from the second to third year after onboarding for existing customers that are at least three years old. The values may then be combined into a CLV for the customer segment using the following formula:

CLV=Y₁+Y₂+Y₃

The CLV may also be discounted by cost of capital to obtain a modified CLV that represents a net present value (NPV) for the customer segment.

After CLVs 212 and assignments 214 are produced for all customer segments 210, management apparatus 206 may output the CLVs, assignments, and/or other values associated with the customer segments for use in managing sales activity with existing and/or prospective customers of the product. First, the management apparatus may generate a ranking 220 of the customers or customer segments by CLV, potential spending, growth rate, and/or other spending-related metrics. For example, the management apparatus may rank the customers or customer segments in descending order of one or more spending metrics. The management apparatus may also display the ranking and/or metrics in a chart, table, and/or other representation and enable filtering, sorting, and/or grouping of the displayed data by the metrics or features (e.g., industry, location, tier, customer segment, etc.) of the customers. The management apparatus may further export or store the ranking and/or metrics in a file, database, spreadsheet, and/or other format.

Management apparatus 206 may also generate a set of recommendations 222 associated with the customers. For example, the management apparatus may recommend targeting of the customers with different acquisition channels and/or sales strategies based on ranking 220, CLVs 212, growth rate, and/or other metrics. In turn, the recommendations may be used to match acquisition channels and/or sales strategies that require significant resources (e.g., interaction with sales or marketing professionals) to customers or customer segments 210 with higher CLVs and acquisition channels and/or sales strategies that involve fewer resources (e.g., emails, online marketing or sales, etc.) to customers or customer segments with lower CLVs. In another example, the management apparatus may recommend prioritization of prospective customers with high CLV by account executives and assigning of customers with low CLV to renewal specialists or other lower-cost positions.

Management apparatus 206 may additionally generate a set of account assignments 236 based on ranking 220 and/or recommendations 222. For example, the management apparatus may assign accounts of the customers to different sales and/or marketing professionals so that customers that are most likely to convert and/or that are associated with the highest CLVs 212 may be targeted by the most effective sales and/or marketing professionals. The account assignments may also be made so that customers in different market segments (e.g., industries, sizes, tiers, locations, etc.) are assigned to sales and/or marketing professionals with expertise in marketing or selling products to those market segments. In another example, the management apparatus may calculate sales quotas for the sales professionals based on the CLVs and predicted growth rates of customers assigned to the sales professionals. Consequently, the system of FIG. 2 may improve sales and/or marketing of products by allowing territory planning and/or other sales or marketing activities to be conducted based on CLVs, growth rates, and/or customer segments for customers of the product.

Those skilled in the art will appreciate that the system of FIG. 2 may be implemented in a variety of ways. First, analysis apparatus 202, management apparatus 206, and/or data repository 134 may be provided by a single physical machine, multiple computer systems, one or more virtual machines, a grid, one or more databases, one or more file systems, and/or a cloud computing system. Analysis apparatus 202 and management apparatus 206 may additionally be implemented together and/or separately by one or more hardware and/or software components and/or layers.

Second, account features 224, spending features 226, recruiting features 228, historic data 218, and/or other data used to produce growth rates 216, CLVs 212, and/or may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history), profile completeness, and/or estimates of potential spending or other metrics from surveys, polls, or other types of feedback.

Finally, different techniques may be used to implement statistical model 208, produce customer segments 210, and/or assign customers to the customer segments. For example, statistical model 208 may be implemented using artificial neural networks, Bayesian networks, support vector machines, clustering techniques, regression models, random forests, and/or other types of machine learning techniques. Similarly, various clustering and/or classification techniques may be used to generate the customer segments and/or assign new and/or existing customers to the customer segments.

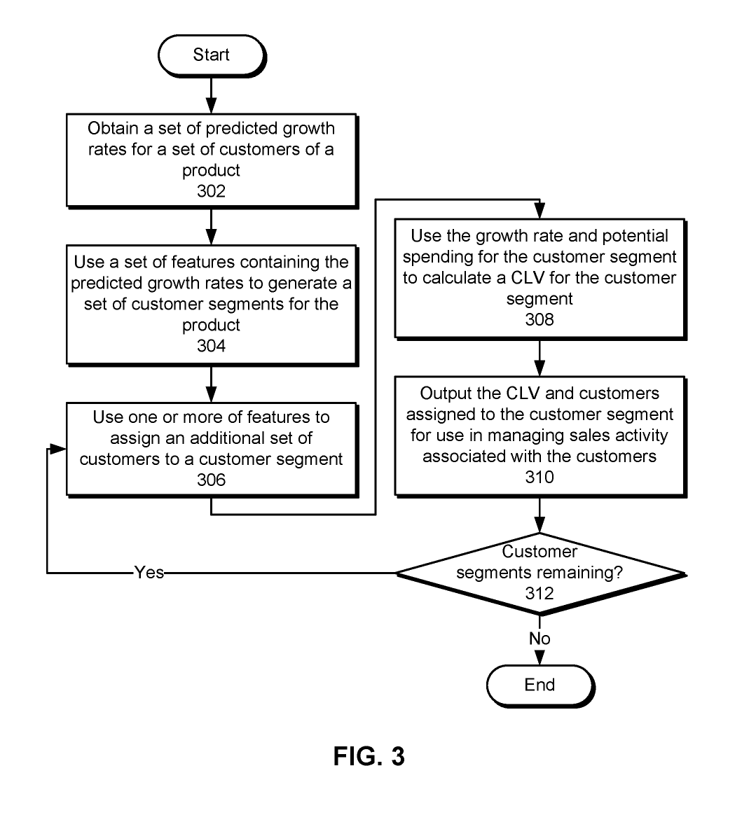

FIG. 3 shows a flowchart illustrating the processing of data in accordance with the disclosed embodiments. More specifically, FIG. 3 shows a flowchart of model-based segmentation of a set of customers of a product. In one or more embodiments, one or more of the steps may be omitted, repeated, and/or performed in a different order. Accordingly, the specific arrangement of steps shown in FIG. 3 should not be construed as limiting the scope of the embodiments.

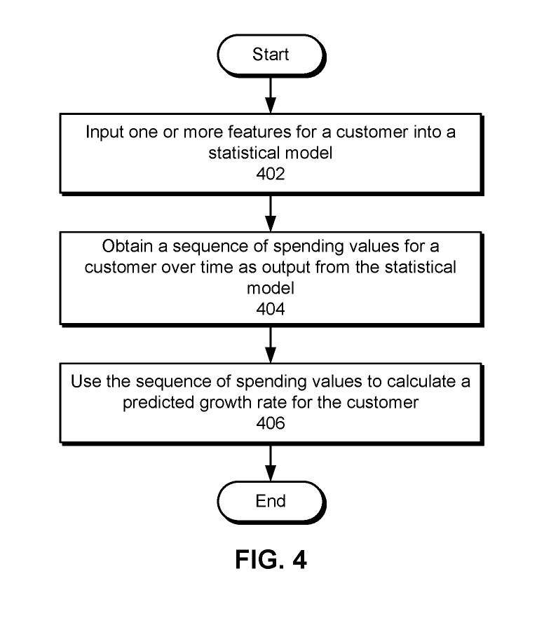

Initially, a set of predicted growth rates is obtained for a set of customers of a product (operation 302), as described in further detail below with respect to FIG. 4. Each predicted growth rate may represent the predicted change in a customer's spending over a pre-specified period (e.g., number of months or years). Next, a set of features containing the predicted growth rates is used to generate a set of customer segments for the product (operation 304). For example, a clustering technique may be used to obtain the customer segments as clusters of similar growth rate, potential spending, industry, account tier, company size, and/or other features in the customers.

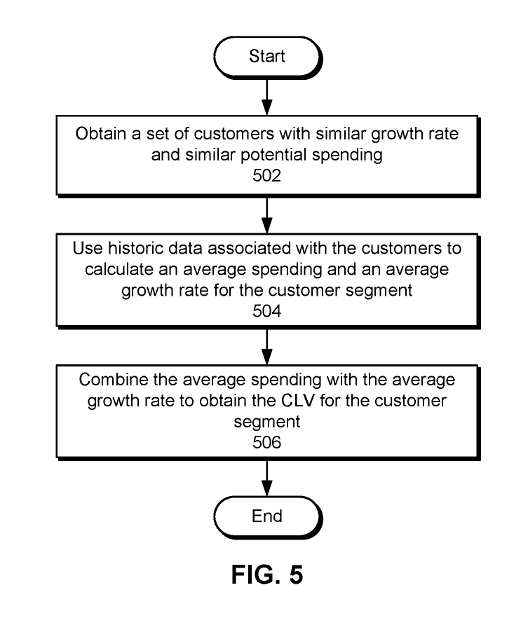

After the customer segments are generated, one or more features are used to assign an additional set of customers to a given customer segment (operation 306). For example, a decision tree and/or set of classification rules may be used to assign prospective customers of the product to the customer segment based on the customers' predicted growth rates, potential spending, and/or other features. The growth rate and potential spending for the customer segment are then used to calculate a CLV for the customer segment (operation 308), as described in further detail below with respect to FIG. 5.

Finally, the CLV and customers assigned to the customer segment are outputted for use in managing sales activity associated with the customers (operation 310). For example, the customer segments may be displayed in descending order of CLV, growth rate, potential spending, and/or other metrics. A set of existing and/or prospective customers in each customer segment may also be displayed. In turn, the displayed values may be used in territory planning, TAM analysis, and/or other sales or marketing activities involving the customers. Operations 306-310 may then be repeated for remaining customer segments (operation 312) for the product.

FIG. 4 shows a flowchart illustrating a process of obtaining a predicted growth rate for a customer of a product in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, one or more features for a customer are inputted into a statistical model (operation 402). The feature(s) may include account features (e.g., location, industry, account tier, geographic tier, marketing segment, company size, company growth rate, etc.), spending features (e.g., potential spending, historic spending, historic growth rate, etc.), and/or recruiting features (e.g., number of recruiters, number of hires, number of hiring months, recruiting growth rate, hiring growth rate, etc.).

Next, the statistical model is used to obtain the predicted growth rate for the customer. More specifically, a sequence of spending values for the customer over time is obtained as output from the statistical model (operation 404) and used to calculate the predicted growth rate for the customer (operation 406). For example, the statistical model may output values of $5,000, $6,000, $7,000, and $9,000 for spending during onboarding, the first year after onboarding, the second year after onboarding, and the third year after onboarding for the customer. In turn, the predicted growth rate for the customer may be calculated as (5000+6000+7000+9000)/(3*5000)−1, or 0.8. Operations 402-406 may be repeated for remaining existing and/or prospective customers of the product.

FIG. 5 shows a flowchart illustrating a process of calculating a CLV for a customer segment in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a set of customers with similar growth rate and similar potential spending is obtained (operation 502). For example, a clustering technique and/or set of classification rules may be used to associate customers with similar growth rate, potential spending, and/or other features with the same customer segment. Next, historic data associated with the customers is used to calculate an average spending and an average growth rate for the customer segment (operation 504). For example, values of historic spending for the customers may be used to calculate an average spending and/or growth rate of the customers in the first, second, and third years after onboarding. Finally, the average spending is combined with the growth rate to obtain the CLV for the customer segment (operation 506). For example, the average spending for the first year after onboarding may be combined with the average growth rate for a number of subsequent years to obtain values of average spending for the subsequent years. The CLV may then be calculated by summing the average spending values for a pre-specified number of years after onboarding.

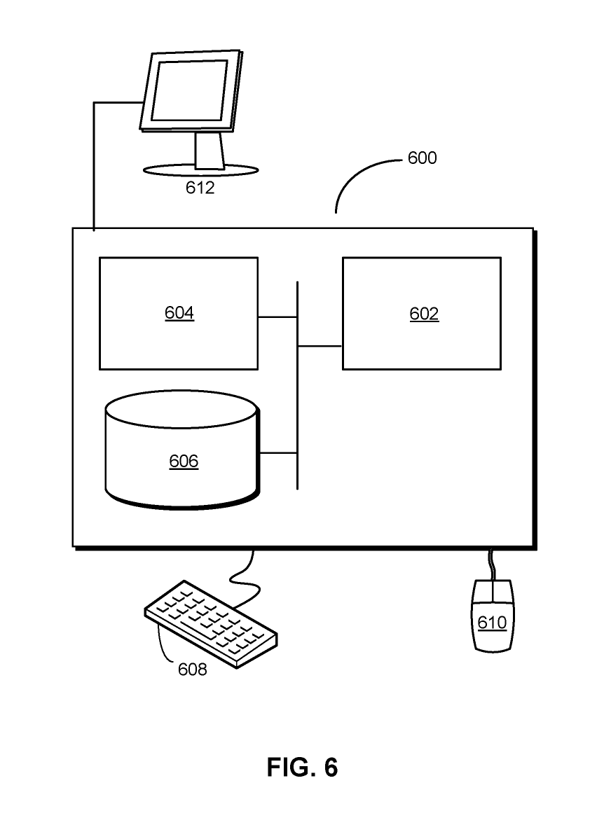

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system may include an analysis apparatus and a management apparatus, one or both of which may alternatively be termed or implemented as a module, mechanism, or other type of system component. The analysis apparatus may obtain a set of predicted growth rates for a first set of customers of a product. Next, the analysis apparatus may use a set of features that include the predicted growth rates to generate a set of customer segments for the product, such that each customer segment in the set of customer segments has a similar growth rate and a similar potential spending. The analysis apparatus may then use the similar growth rate and the similar potential spending to calculate a CLV for each customer segment. Finally, the management apparatus may output the CLV with a second (e.g., prospective) set of customers assigned to the customer segment for use in managing sales activity with the second set of customers.

In addition, one or more components of computer system 600 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that generates customer segments and CLVs for a set of remote customers.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of predicted growth rates for a first set of customers of a product;
using a set of features comprising the predicted growth rates to generate, by one or more computer systems, a set of customer segments for the product, wherein each customer segment in the set of customer segments comprises a similar growth rate and a similar potential spending; and
for each customer segment in the set of customer segments:
using the similar growth rate and the similar potential spending to calculate, by the one or more computer systems, a customer lifetime value (CLV) for the customer segment; and
outputting the CLV with a second set of customers assigned to the customer segment for use in managing sales activity with the second set of customers.

2. The method of claim 1, further comprising:
using one or more of the features to assign the second set of customers to the customer segment.

3. The method of claim 2, wherein using the one or more of the features to assign the second set of customers to the customer segment comprises:
applying a set of classification rules to the one or more of the features to assign the second set of customers to the customer segment.

4. The method of claim 1, wherein obtaining the set of predicted growth rates for the first set of customers comprises:
inputting one or more of the features for the first set of customers into a statistical model; and
using the statistical model to obtain the predicted growth rates for the first set of customers.

5. The method of claim 4, wherein using the statistical model to obtain the predicted growth rates comprises:
obtaining a sequence of spending values for a customer over time as output from the statistical model; and
using the sequence of spending values to calculate a predicted growth rate for the customer.

6. The method of claim 1, wherein using the set of features to generate the set of customer segments comprises:
obtaining the customer segments as clusters of similar features in the first set of customers.

7. The method of claim 1, wherein using the similar growth rate and the similar potential spending to calculate the CLV for the customer segment comprises:
obtaining a subset of customers with the similar growth rate and the similar potential spending from the first set of customers;
using historic data associated with the subset of customers to calculate an average spending and an average growth rate for the customer segment; and
combining the average spending with the average growth rate to obtain the CLV for the customer segment.

8. The method of claim 1, wherein the set of features further comprises:
a potential spending; and
an account feature.

9. The method of claim 8, wherein the account feature is at least one of:
a location;
an industry;
an account tier;
a geographic tier;
a marketing segment; and
a company size.

10. The method of claim 8, wherein the set of features further comprises a recruiting feature.

11. The method of claim 10, wherein the recruiting feature is at least one of:
a number of hires;
a number of recruiters;
a number of hiring months;
a recruiting growth rate; and
a hiring growth rate.

12. The method of claim 1, wherein:
the first set of customers comprises existing customers of the product; and
the second set of customers comprises potential customers of the product.

13. An apparatus, comprising:
one or more processors; and
memory storing instructions that, when executed by the one or more processors, cause the apparatus to:
obtain a set of predicted growth rates for a first set of customers of a product;
use a set of features comprising the predicted growth rates to generate a set of customer segments for the product, wherein each customer segment in the set of customer segments comprises a similar growth rate and a similar potential spending; and
for each customer segment in the set of customer segments:
use the similar growth rate and the similar potential spending to calculate a customer lifetime value (CLV) for the customer segment; and
output the CLV with a second set of customers assigned to the customer segment for use in managing sales activity with the second set of customers.

14. The apparatus of claim 13, wherein the memory further stores instructions that, when executed by the one or more processors, cause the apparatus to:
use one or more of the features to assign the second set of customers to the customer segment.

15. The apparatus of claim 14, wherein using the one or more of the features to assign the second set of customers to the customer segment comprises:
applying a set of classification rules to the one or more of the features to assign the second set of customers to the customer segment.

16. The apparatus of claim 13, wherein obtaining the set of predicted growth rates for the first set of customers comprises:
inputting one or more of the features for the first set of customers into a statistical model; and
using the statistical model to obtain the predicted growth rates for the first set of customers.

17. The apparatus of claim 13, wherein using the set of features to generate the set of customer segments comprises:
obtaining the customer segments as clusters of similar features in the first set of customers.

18. The apparatus of claim 13, wherein using the similar growth rate and the similar potential spending to calculate the CLV for the customer segment comprises:
obtaining a subset of customers with the similar growth rate and the similar potential spending from the first set of customers;
using historic data associated with the subset of customers to calculate an average spending and an average growth rate for the customer segment; and
combining the average spending with the average growth rate to obtain the CLV for the customer segment.

19. A system, comprising:
an analysis module comprising a non-transitory computer-readable medium storing instructions that, when executed by, cause the system to:
obtain a set of predicted growth rates for a first set of customers of a product;
use a set of features comprising the predicted growth rates to generate a set of customer segments for the product, wherein each customer segment in the set of customer segments comprises a similar growth rate and a similar potential spending; and
for each customer segment in the set of customer segments, use the similar growth rate and the similar potential spending to calculate a customer lifetime value (CLV) for the customer segment; and
a management module comprising a non-transitory computer-readable medium storing instructions that, when executed, cause the system to output the CLV with a second set of customers assigned to the customer segment for use in managing sales activity with the second set of customers.

20. The system of claim 19, wherein the non-transitory computer-readable medium of the analysis apparatus further stores instructions that, when executed, cause the system to:
use one or more of the features to assign the second set of customers to the customer segment.
